(19) United States
(12) Patent Application Publication
(10) Pub. No.: US 2023/0391472 A1
(43) Pub. Date: Dec. 7, 2023

(54) SYSTEM AND METHOD FOR ASSISTING A NON-PILOT IN TAKING CORRECTIVE ACTION

(71) Applicant: HONEYWELL INTERNATIONAL INC., Charlotte, NC (US)

(72) Inventors: Gireesh Kumar R N, Bangalore (IN); Prem Kumar T, Bangalore (IN); Janakiram Thiyagarajan, Bangalore (IN); Kalaiarasu Velappan, Bangalore (IN); Karthic V, Bangalore (IN)

(73) Assignee: HONEYWELL INTERNATIONAL INC., Charlotte, NC (US)

(21) Appl. No.: 17/815,280

(22) Filed: Jul. 27, 2022

(30) Foreign Application Priority Data
Jun. 6, 2022 (IN) 202211032222

(51) Int. Cl. B64D 45/08

(52) U.S. Cl. CPC B64D 45/08; B64D 2045/0085

(57) ABSTRACT

A system and method to assist a non-pilot in taking corrective action includes monitoring, in a health monitoring system, a state of health of an enabled aircraft autoland system to determine if a subsystem or component of the autoland system is in a fault condition that will inhibit operation of the autoland system. When the subsystem or component of the enabled autoland system is inoperable, The health monitoring system determines if the fault condition can be corrected by the non-pilot, by comparing the fault condition to a set of fault conditions in a fault condition database. When the fault condition can be corrected by the non-pilot, a display device is commanded, via the health monitoring system, to render a three-dimensional (3D) cockpit view of instructions for correcting the fault.

### CROSS-REFERENCE TO RELATED APPLICATION

This application claims priority to India Provisional Patent Application No. 202211032222, filed Jun. 6, 2022, the entire content of which is incorporated by reference herein.

### TECHNICAL FIELD

The present invention generally relates to a system for assisting a non-pilot in taking corrective action, and more particularly relates to a system for assisting a non-pilot in taking corrective action when an aircraft autoland system is enabled.

### BACKGROUND

Many aircraft include an autoland system. As is generally known, an autoland system can take complete control of, and land, the aircraft in an emergency, such as in the unlikely event the pilot is unable to fly. The autoland system can be enabled automatically or manually. For example, some autoland systems are configured to be automatically enabled when, via a decision algorithm, it is determined that the pilot is unable to fly. Some autoland systems are also configured such that any flight crew member or any alert passenger can manually engage the system by pushing a button in the cockpit.

Regardless of how the autoland system is enabled, when it is, the autoland system automatically lands the aircraft without user intervention. To do so, the autoland system calculates a flight plan to the most suitable airport, broadcasts intent to air traffic control (ATC), initiates an approach to the runway, and automatically lands the aircraft. The autoland system also automatically applies the aircraft brakes, stops the aircraft, and shuts down the engine(s). As may thus be appreciated, the autoland system comprises numerous avionic systems and components including, for example, the flight management system (FMS), the flight control system (FCS), numerous sensors and system monitors, and generates and supplies commands to manipulate various mechanical systems, such as various flight control system, aircraft landing gear, the aircraft brakes, and the engine(s).

Although unlikely, it is postulated that a subsystem or component of the autoland system could fail or otherwise become inoperable when the autoland system is enabled. Should such unlikely event occur, it is possible that manual intervention could potentially assist in correcting the fault and reengaging the autoland system. However, if the autoland system has been enabled because the pilot has become incapacitated, such manual intervention would need to be performed by a non-pilot. This can be very difficult during a critical phase of flight. Furthermore, a non-pilot will likely be unfamiliar with the cockpit layout, further increasing the difficulty to manually intervene in a timely manner.

Hence, there is a need for a system and method that can assist a non-pilot in manually intervening, in a timely manner, to take corrective action in the unlikely event one or more subsystems or components of an enabled autoland system fail or otherwise become inoperable. The instant disclosure addresses at least this need.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a system for assisting a non-pilot in taking corrective action includes an aircraft autoland system and a health monitoring system. The aircraft autoland system is configured, when enabled, to automatically land an aircraft without user intervention. The health monitoring system is in operable communication with the aircraft autoland system and is configured to determine when the aircraft autoland system is enabled and, when the aircraft autoland system is enabled, to monitor a state of health of the aircraft autoland system to determine if a subsystem or component of the autoland system is in a fault condition that will inhibit operation of the autoland system. When the subsystem or component of the enabled autoland system is inoperable, the health monitoring system is further configured to determine if the fault condition can be corrected by the non-pilot, by comparing the fault condition to a set of fault conditions in a fault condition database, and when the fault condition can be corrected by the non-pilot, command a display device to render a three-dimensional (3D) cockpit view of instructions for correcting the fault. The 3D cockpit view includes graphics depicting where, in the cockpit, corrective action for eliminating the fault is to occur and textual instructions for implementing the corrective action.

In another embodiment, a method to assist a non-pilot in taking corrective action includes monitoring, in a health monitoring system, a state of health of an enabled aircraft autoland system to determine if a subsystem or component of the autoland system is in a fault condition that will inhibit operation of the autoland system. When the subsystem or component of the enabled autoland system is inoperable, The health monitoring system determines if the fault condition can be corrected by the non-pilot, by comparing the fault condition to a set of fault conditions in a fault condition database. When the fault condition can be corrected by the non-pilot, a display device is commanded, via the health monitoring system, to render a three-dimensional (3D) cockpit view of instructions for correcting the fault. The 3D cockpit view includes graphics depicting where, in the cockpit, corrective action for eliminating the fault is to occur and textual instructions for implementing the corrective action.

In yet another embodiment, a system for assisting a non-pilot in taking corrective action includes an aircraft autoland system, a fault condition database, a display device, and a health monitoring system. The aircraft autoland system is configured, when enabled, to automatically land an aircraft without user intervention. The fault condition database has a set of fault conditions stored therein. The display device is configured, in response to display commands, to render one or more images. The health monitoring system is in operable communication with the aircraft autoland system, the fault condition database, and the display device. The health monitoring system is configured to determine when the aircraft autoland system is enabled and, when the aircraft autoland system is enabled, monitor a state of health of the aircraft autoland system to determine if a subsystem or component of the autoland system is in a fault condition that will inhibit operation of the autoland system. When the subsystem or component of the enabled autoland system is inoperable, the health monitoring system is further configured to determine if the fault condition can be corrected by the non-pilot, by comparing the fault condition to the set of fault conditions in the fault condition database and when the fault condition can be corrected by the non-pilot, command the display device to render a three-dimensional (3D) cockpit view of instructions for correcting the fault. The 3D cockpit view includes graphics depicting where, in the cockpit, corrective action for eliminating the fault is to occur and textual instructions for implementing the corrective action.

Furthermore, other desirable features and characteristics of the system and method will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 is a functional block diagram of one embodiment of a system for assisting a non-pilot in taking corrective action;

FIG. 2 depicts a simplified example of a 3D cockpit view that may be rendered on a display device of the system in FIG. 1; and

FIG. 3 depicts a process, in flowchart form, of a method that may be implemented in the system of FIG. 1.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

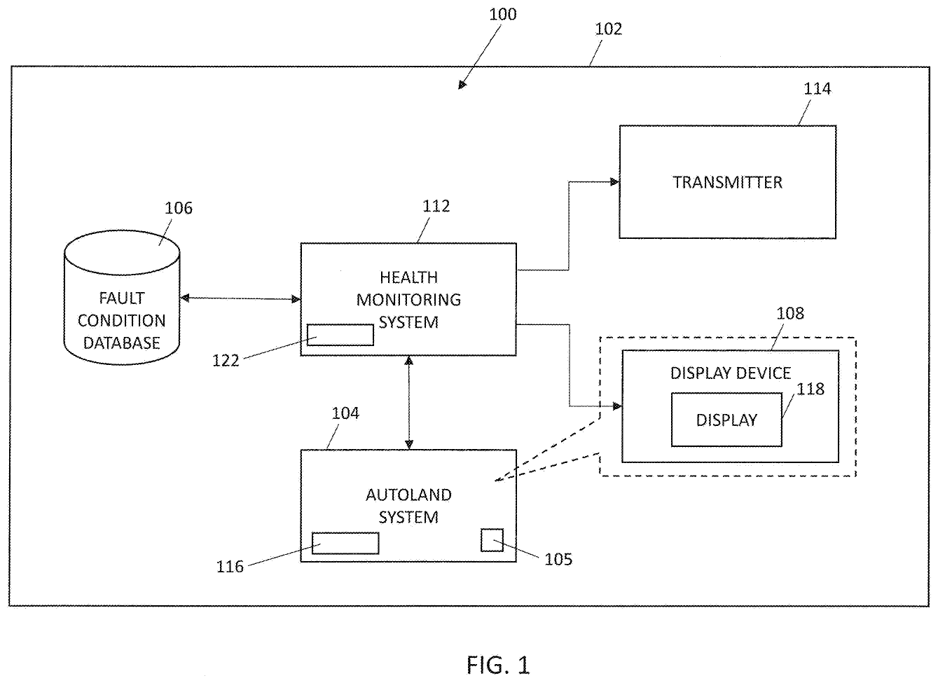

Referring to FIG. 1, one embodiment of a functional block diagram of a system 100 for assisting a non-pilot in taking corrective action is depicted. The system 100, which is preferably installed in an aircraft 102, includes an aircraft autoland system 104, a fault condition database 106, a display device 108, and a health monitoring system 112. As FIG. 1 further depicts, the system 100 may, in some embodiments, additionally include a transmitter 114.

The aircraft autoland system 104 is configured, when enabled, to automatically land the aircraft 102 without user intervention. The aircraft autoland system 104 may be enabled either automatically or manually. For example, the aircraft autoland system 104 may be configured to continuously monitor whether a pilot has interacted with the cockpit and to be automatically enabled when the pilot has not interacted with the cockpit for a predetermined amount of time. The aircraft autoland system 104 may be manually enabled by, for example, a user (pilot or non-pilot) manipulating a switch or button 105.

Regardless of how the aircraft autoland system 104 becomes enabled, when it is enabled, the various avionic systems and subsystems that comprise the autoland system (e.g., flight management system (FMS), flight control system (FCS) autopilot system, flight director, auto throttle system, braking system, engine controller, etc.) are engaged and controlled, via one or more suitably configured and programmed processors 116, to automatically land the aircraft 102.

The fault condition database 106 has a set of fault conditions stored therein. The fault conditions stored in the fault condition database 106 include fault conditions that have been previously determined, and each has been categorized as a fault condition that can be corrected by a non-pilot or a fault condition that cannot be corrected by a pilot. The fault condition database 106 may also include data regarding the location of where, in the cockpit, corrective action may be taken for each fault condition that can be corrected by a non-pilot. The criterion/criteria used to categorize a fault condition as correctable or not correctable by a pilot may vary from aircraft-type to aircraft-type, from cockpit to cockpit, etc., and is based on experience and judgement.

The display device 108 is configured, in response to display commands, to render one or more images. To do so, the display device 108 may include any number and type of image generating devices on which one or more avionic displays 118 may be generated. The display device 108 may be fixed or portable. For example, the display device may be affixed to the static structure of the aircraft cockpit as, for example, a Head Down Display (HDD) or Head Up Display (HUD) unit. In some embodiments, the display device 108 may assume the form of a portable device such as a pilot-worn display device, an Electronic Flight Bag (EFB), a laptop, or a tablet computer carried into the aircraft cockpit by a pilot. The display device 108 may be implemented separate from or, as depicted using the dotted lines in FIG. 1, a part of the aircraft autoland system 104.

As noted above, at least one avionic display 118 is generated on the display device 108 during operation of the system 100. As used herein, the term “avionic display” is synonymous with the term “aircraft-related display” and “cockpit display” and encompasses displays generated in textual, graphical, cartographical, and other formats. The system 100 can simultaneously generate various types of lateral and vertical avionic displays 118 on which three-dimensional (3D) graphics, text, and other graphics are rendered.

The health monitoring system 112 is in operable communication with the aircraft autoland system 104, the fault condition database 106, and the display device 108. The health monitoring system 112, via one or more suitably programmed processors 122, is configured to determine when the aircraft autoland system 104 is enabled. The health monitoring system 112 is additionally configured, when the aircraft autoland system 104 is enabled, to monitor the state of health of the aircraft autoland system 104 to determine if a subsystem or component of the aircraft autoland system 104 is in a fault condition that will inhibit (or prevent) operation of the aircraft autoland system 104. It will be appreciated that the health monitoring system 112 may be any one of numerous health monitoring systems 112 known in the art, either presently or in the future, that have the capability of monitoring the health state of a system.

No matter the specific health monitoring system 112 that is implemented, the health monitoring system 112 is additionally configured, upon determining that a subsystem or component of the enabled aircraft autoland system 104 is in a fault condition, to determine if the fault condition can be corrected by a non-pilot. To do so, the health monitoring system 112 compares the fault condition to the set of fault conditions in the fault condition database 106. If, based on this comparison, the health monitoring system 112 determines that the fault condition can be corrected by the non-pilot, the health monitoring system 112 retrieves data regarding the location of where, in the cockpit, corrective action may be taken, and commands the display device 108 to render a 3D cockpit view of instructions for correcting the fault. Preferably, the 3D cockpit view includes at least graphics depicting where, in the cockpit, the corrective action for eliminating the fault is to occur and textual instructions for implementing the corrective action.

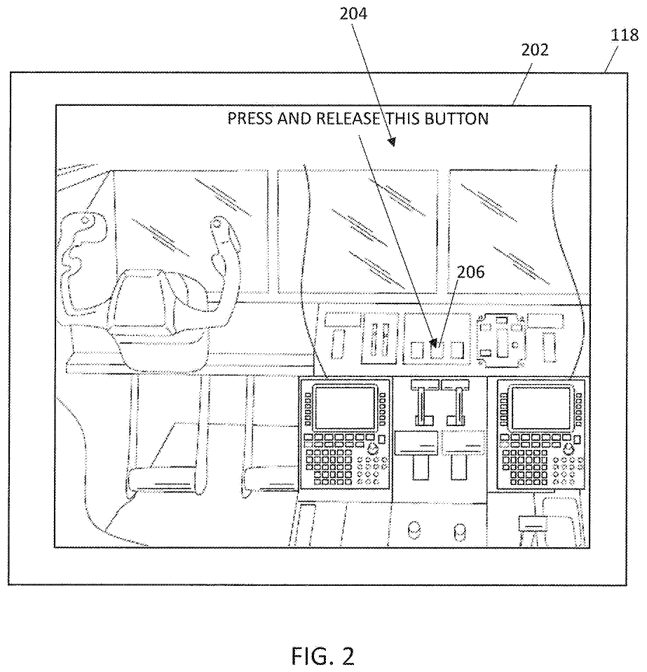

One simplified example of a suitable 3D cockpit view, for the hypothetical case in which a fault condition can be corrected by pressing and releasing a specific button in the cockpit, is depicted in FIG. 2. As illustrated therein, the 3D cockpit view 202 that is rendered on the display device 108, includes a graphic 204 depicting where in the cockpit the specific switch 206 is located, and the textual instructions for implementing the corrective action—in this case, the corrective action is “PRESS AND RELEASE THIS BUTTON.”

In addition to the textual instructions, the health monitoring system 112 may, at least in some embodiments, be further configured to generate audible instructions for implementing the corrective actions. In such embodiments, the audible instructions preferably match the textual instructions. Thus, for the simplified example depicted in FIG. 2, the audible instructions would be, “Press and release this button.”

The health monitoring system 112 is further configured to whether or not the corrective action provided to the non-pilot eliminated the fault and to selectively generate an appropriate alert. Specifically, if the health monitoring system 112 determines that the corrective action did eliminate the fault, the health monitoring system 112 generates an alert indicating that the aircraft autoland system 104 is no longer in the fault condition. Conversely, if the health monitoring system 112 determines that the corrective action did not eliminate the fault, the health monitoring system 112 generates an alert indicating that the aircraft autoland system 104 is still in the fault condition and is inoperable. These generated alerts may be visual, audible, or a combination of both.

Referring again to FIG. 1, it was previously mentioned that the system 100, at least in some embodiments, may additionally include a transmitter 114. The transmitter 114, when included, is in operable communication with the health monitoring system 112. The transmitter 114 is coupled to receive, and is configured to transmit, the generated alert(s) to a ground station (not illustrated).

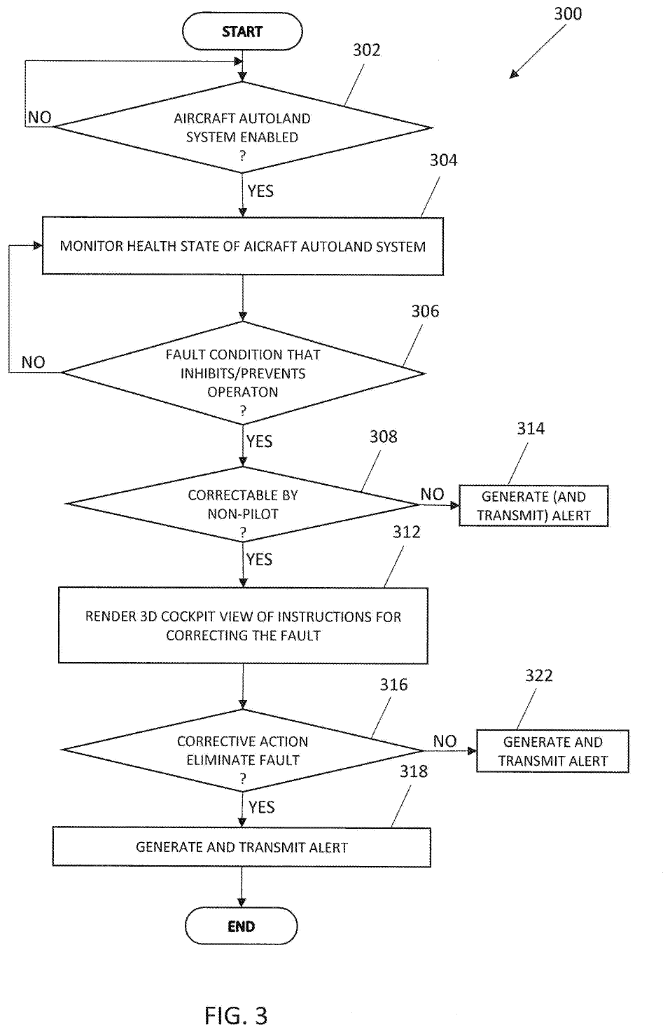

Having described the overall functionality of the system 100, a description of a method to assist a non-pilot in taking corrective action that is implemented in the system 100 will be described. The method 300, which is depicted in flowchart form in FIG. 3, represents various embodiments of a method for assisting a non-pilot in taking corrective action. For illustrative purposes, the following description of method 300 may refer to elements mentioned above in connection with FIG. 1. In practice, portions of method 300 may be performed by different components of the described system 100. It should be appreciated that method 300 may include any number of additional or alternative tasks, the tasks shown in FIG. 3 need not be performed in the illustrated order, and method 300 may be incorporated into a more comprehensive procedure or method having additional functionality not described in detail herein. Moreover, one or more of the tasks shown in FIG. 3 could be omitted from an embodiment of the method 300 if the intended overall functionality remains intact.

The method 300 starts and the health monitoring system 112 determines if the aircraft autoland system 104 is enabled (302). If it is, then the health monitoring system 112 monitors the state of health of aircraft autoland system 104 (304) and determines if a subsystem or component of the aircraft autoland system 104 is in a fault condition that will inhibit or prevent operation of the aircraft autoland system 104 (306).

When the subsystem or component of the enabled aircraft autoland system 104 is in a fault condition that will inhibit or prevent operation of the aircraft autoland system 104, the health monitoring system 112 determines if the fault condition can be corrected by a non-pilot (308). As noted above, this is done by comparing the fault condition to the set of fault conditions in a fault condition database. When the fault condition can be corrected by the non-pilot, the health monitoring system 112 retrieves data regarding the location of where, in the cockpit, corrective action may be taken and commands the display device 108 to render the three-dimensional (3D) cockpit view of instructions for correcting the fault (312). Conversely, when the fault condition cannot be corrected by a non-pilot, the health monitoring system 112 generates an alert indicating that the aircraft autoland system 104 is inoperable (314). This alert may be transmitted to a ground station.

As FIG. 3 also depicts, the health monitoring system also determines if the corrective action eliminated the fault (316). If so, an alert is generated indicating that the aircraft autoland system 104 is no longer in the fault condition (318). If not, an alert is generated indicating that the autoland system is still in the fault condition (322). In both instances, the generated alert is transmitted to a ground station.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A system for assisting a non-pilot in taking corrective action, comprising:
an aircraft autoland system configured, when enabled, to automatically land an aircraft without user intervention; and
a health monitoring system in operable communication with the aircraft autoland system, the health monitoring system configured to (i) determine when the aircraft autoland system is enabled, (ii) when the aircraft autoland system is enabled, monitor a state of health of the aircraft autoland system to determine if a subsystem or component of the autoland system is in a fault condition that will inhibit operation of the autoland system, and (iii) when the subsystem or component of the enabled autoland system is inoperable:
determine if the fault condition can be corrected by the non-pilot, by comparing the fault condition to a set of fault conditions in a fault condition database; and
when the fault condition can be corrected by the non-pilot, command a display device to render a three-dimensional (3D) cockpit view of instructions for correcting the fault,
wherein the 3D cockpit view includes (i) graphics depicting where, in the cockpit, corrective action for eliminating the fault is to occur and (ii) textual instructions for implementing the corrective action.

2. The system of claim 1, wherein the health monitoring system is further configured to generate audible instructions for implementing the corrective actions, wherein the audible instructions match the textual instructions.

3. The system of claim 1, wherein the health monitoring system is further configured to:
determine if the corrective action eliminated the fault;
generate an alert indicating that the autoland system is no longer in the fault condition when it is determined that the corrective action did eliminate the fault; and
generate an alert indicating that the autoland system is still in the fault condition when it is determined that corrective action did not eliminate the fault.

4. The system of claim 3, further comprising:
a transmitter in operable communication with the health monitoring system, the transmitter coupled to receive, and configured to transmit, the generated alert to a ground station.

5. The system of claim 1, wherein the health monitoring system is further configured to generate an alert indicating that the autoland system is inoperable when the fault condition cannot be corrected by the non-pilot.

6. The system of claim 5, further comprising:
a transmitter in operable communication with the health monitoring system, the transmitter coupled to receive, and configured to transmit, the generated alert to a ground station.

7. The system of claim 1, further comprising:
the fault condition database having the set of fault conditions stored therein, the fault condition database in operable communication with the health monitoring system.

8. The system of claim 1, further comprising:
the display device in operable communication with the health monitoring system, the display device configured, in response to commands supplied by the health monitoring system, to render the 3D cockpit view of the instructions for correcting the fault.

9. The system of claim 8, wherein the autoland system comprises the display device.

10. A method to assist a non-pilot in taking corrective action, comprising the steps of:
monitoring, in a health monitoring system, a state of health of an enabled aircraft autoland system to determine if a subsystem or component of the autoland system is in a fault condition that will inhibit operation of the autoland system; and
when the subsystem or component of the enabled autoland system is inoperable:
determining, in the health monitoring system, if the fault condition can be corrected by the non-pilot, by comparing the fault condition to a set of fault conditions in a fault condition database;
when the fault condition can be corrected by the non-pilot, commanding a display device, via the health monitoring system, to render a three-dimensional (3D) cockpit view of instructions for correcting the fault,
wherein the 3D cockpit view includes (i) graphics depicting where, in the cockpit, corrective action for eliminating the fault is to occur and (ii) textual instructions for implementing the corrective action.

11. The method of claim 10, further comprising:
generating, via the health monitoring system, audible instructions for implementing the corrective actions, wherein the audible instructions match the textual instructions.

12. The method of claim 10, further comprising:
determining, in the health monitoring system, if the corrective action eliminated the fault;
generating an alert indicating that the autoland system is no longer in the fault condition when it is determined that the corrective action did eliminate the fault; and
generating an alert indicating that the autoland system is still in the fault condition when it is determined that corrective action did not eliminate the fault.

13. The method of claim 12, further comprising:
transmitting, via a transmitter, the generated alert to a ground station.

14. The method of claim 10, further comprising:
generating an alert indicating that the autoland system is inoperable when the fault condition cannot be corrected by the non-pilot.

15. A system for assisting a non-pilot in taking corrective action, comprising:
an aircraft autoland system configured, when enabled, to automatically land an aircraft without user intervention;
a fault condition database having a set of fault conditions stored therein;
a display device configured, in response to display commands, to render one or more images; and
a health monitoring system in operable communication with the aircraft autoland system, the fault condition database, and the display device, the health monitoring system configured to (i) determine when the aircraft autoland system is enabled, (ii) when the aircraft autoland system is enabled, monitor a state of health of the aircraft autoland system to determine if a subsystem or component of the autoland system is in a fault condition that will inhibit operation of the autoland system, and (iii) when the subsystem or component of the enabled autoland system is inoperable:
determine if the fault condition can be corrected by the non-pilot, by comparing the fault condition to the set of fault conditions in the fault condition database; and
when the fault condition can be corrected by the non-pilot, command the display device to render a three-dimensional (3D) cockpit view of instructions for correcting the fault,
wherein the 3D cockpit view includes (i) graphics depicting where, in the cockpit, corrective action for eliminating the fault is to occur and (ii) textual instructions for implementing the corrective action.

16. The system of claim 15, wherein the health monitoring system is further configured to generate audible instructions for implementing the corrective actions, wherein the audible instructions match the textual instructions.

17. The system of claim 15, wherein the health monitoring system is further configured to:
determine if the corrective action eliminated the fault;
generate an alert indicating that the autoland system is no longer in the fault condition when it is determined that the corrective action did eliminate the fault; and
generate an alert indicating that the autoland system is still in the fault condition when it is determined that corrective action did not eliminate the fault.

18. The system of claim 17, further comprising:
a transmitter in operable communication with the health monitoring system, the transmitter coupled to receive, and configured to transmit, the generated alert to a ground station.

19. The system of claim 15, wherein the health monitoring system is further configured to generate an alert indicating that the autoland system is inoperable when the fault condition cannot be corrected by the non-pilot.

20. The system of claim 19, further comprising:
a transmitter in operable communication with the health monitoring system, the transmitter coupled to receive, and configured to transmit, the generated alert to a ground station.
